(19) United States
(12) Patent Application Publication
(10) Pub. No.: US 2023/0342846 A1
(43) Pub. Date: Oct. 26, 2023

(54) MICRO-LOAN SYSTEM

(71) Applicant: ADP, Inc., ROSELAND, NJ (US)

(72) Inventors: Roberto Silveira, Porto Alegre (BR); Fabiano Pereira, Porto Alegre (BR); Leandro Silva, Porto Alegre (BR); Matheus Frantz, Porto Alegre (BR); Daniel Carvalho, Porto Alegre (BR); Julio Hartmann, Porto Alegre (BR); Bruno Moura, Porto Alegre (BR); Iury Castro, Porto Alegre (BR); Lucas Boscaini, Porto Alegre (BR); Ezequiel Primaz, Porto Alegre (BR)

(73) Assignee: ADP, Inc., ROSELAND, NJ (US)

(21) Appl. No.: 18/138,611

(22) Filed: Apr. 24, 2023

Related U.S. Application Data
(63) Continuation of application No. 16/279,582, filed on Feb. 19, 2019, now abandoned.

(51) Int. Cl. G06Q 40/03; G06Q 20/22; G06Q 20/38; G06Q 20/24; G06N 20/00; G06Q 40/12

(52) U.S. Cl. CPC G06Q 40/03; G06Q 20/223; G06Q 20/389; G06Q 20/24; G06N 20/00; G06Q 40/125; G06F 16/2365

(57) ABSTRACT

A method, computer system, and computer program product are provided for facilitating peer-to-peer micro-loan transactions. A micro-loan system determines integrity scores for a plurality of users. The integrity scores are based on human capital management information and peer-submitted feedback. These micro-loan system receives a loan transaction request from a borrower-user, and determines a risk score for the loan transaction based the borrower's integrity score. The micro-loan system identifies potential lenders based on the determined transaction risk and the lenders' integrity scores. The micro-loan system facilitates a negotiation between the borrower and the potential lenders to determine transaction terms. When terms are finalized, the loan transaction and the transaction terms are recorded in a distributed ledger, and loan funds are remitted to the borrower. Upon repayment of the loan transaction, the micro-loan system solicits feedback from the borrower and the lender, and updates the respective integrity scores based on received feedback.

### CROSS-REFERENCE TO RELATED APPLICATIONS

This application claims priority and benefit under 35 U.S.C. § 120 as a continuation of U.S. Ser. No. 16/279,582, filed Feb. 19, 2019, the contents of which are hereby incorporated by reference herein in entirety.

### BACKGROUND INFORMATION

### 1. Field

The present disclosure relates to use of smart contracts implemented solely in a computer network for use with distributed ledgers.

### 2. Background

A distributed ledger, as used throughout this document, refers to a computer-only technology that enables a distributed recordation of transactions through the distributed ledger maintained by a network of computers. A blockchain is an example of a distributed ledger. BITCOIN® is an example of a blockchain technology application.

A blockchain is a type of distributed ledger, which includes digitally-recorded, unmodifiable data in packages called blocks. A distributed ledger is a consensus of replicated, shared, and synchronized digital data geographically spread across multiple computers which may be in different sites, countries, and/or institutions maintained by many different parties. A distributed ledger can be public, such as BITCOIN®, where there is no limitation on who may participate in the network, or private, where only approved parties are permitted to participate in the network.

### SUMMARY

The illustrative embodiments provide for a method, system, and computer program product for facilitating peer-to-peer micro-loan transactions. A computer system determines an integrity score for each user of a plurality of users. The integrity score for each user is based on human capital management information for the user and peer-submitted feedback about the user. The computer system receives a loan transaction request from a borrower-user. The computer system determines a risk score for the loan transaction based at least on the borrower-user's integrity score and user information on capital management systems. The computer system identifies a set of lender-users based on the determined risk score and the lender-users' integrity scores. The computer system facilitates a negotiation of transaction terms between the borrower-user and the set of lender-users to determine the transaction terms. Responsive to finalization of the transaction terms, the computer system records the loan transaction and the transaction terms in a distributed ledger, and remitting loan funds to the borrower-user. Responsive to a subsequent repayment of the loan transaction according to the transaction terms, the computer system solicits peer-submitted feedback from at least one of the borrower-user and the set of lender-users. The computer system updates the integrity score for the borrower-user and the set of lender-users based on received peer-submitted feedback regarding the loan transaction.

The illustrative embodiments also contemplate a computer configured to execute program code which implements this method. The illustrative embodiments also contemplate a non-transitory computer-recordable storage medium storing program code, which, when executed, implements this method.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of the illustrative embodiments of the present disclosure when read in conjunction with the accompanying drawings, wherein:

FIG. 1 is an illustration of a data processing environment depicted in accordance with an illustrative embodiment;

FIG. 2 is a block diagram of a micro-loan environment depicted in accordance with an illustrative embodiment;

FIG. 3 is a block diagram of a predictive modeling/indexing depicted in accordance with an illustrative embodiment;

FIG. 4 is an example table for use with a dataset in machine learning depicted in accordance with an illustrative embodiment

FIG. 5 is an illustration of a distributed ledger in the form of a blockchain in accordance with an illustrative embodiment;

FIG. 6 is an illustration of a first step in creating a blockchain in accordance with an illustrative embodiment;

FIG. 7 is an illustration of a second step in creating a blockchain in accordance with an illustrative embodiment;

FIG. 8 is an illustration of a third step in creating a blockchain in accordance with an illustrative embodiment;

FIG. 9 is an illustration of a fourth step in creating a blockchain in accordance with an illustrative embodiment;

FIG. 10 is an illustration of a fifth step in creating a blockchain in accordance with an illustrative embodiment;

FIG. 11 is an illustration of a sixth step in creating a blockchain in accordance with an illustrative embodiment;

FIG. 12 is an illustration of a creation of a smart contract in accordance with an illustrative embodiment;

FIG. 13 is an illustration of an operation of a smart contract in accordance with an illustrative embodiment;

FIG. 14 is a block diagram of an execution environment for executing a smart contract stored on a blockchain in accordance with an illustrative embodiment;

FIG. 15 is a block diagram of a blockchain environment in accordance with an illustrative embodiment;

FIG. 16 is an illustration of a flowchart of a process for predictive modeling and indexing depicted in accordance with an illustrative embodiment;

FIG. 17 is a flowchart of a process for facilitating peer-to-peer micro-loan transactions depicted in accordance with an illustrative embodiment; and

FIG. 18 is a block diagram of a data processing system in accordance with an illustrative embodiment.

### DETAILED DESCRIPTION

The illustrative embodiments recognize and take into account one or more different considerations. For example, the illustrative embodiments recognize and take into account that workers around the globe receive their pay from payroll companies, but they rely on external banks if they need to ask for personal loans in an emergency situation. In almost all situations, external banks need to run detailed risk assessments in order to check if the requester will be able to fulfill repayment of the loan at the end of the contract terms. Another option people tend to use to request loans in smaller quantities is to ask consigned credit companies, which have sometimes cumbersome processes and don't always make clear to their customers all the fees involved in the loan process.

Currently, several startups in the financial technology sector (so-called Fintechs) are making use of data and mobile applications to provide quick, easy-to-use, 24/7 solutions to customers, with very competitive interest rates, closing some gaps that were not being fulfilled by traditional financial institutions. The expected growth rate for Fintech applications is around 20%, with mobile money services that could evolve into a US$3 trillion payments volume opportunity. According to the same research, the 7 key technology enablers for Fintech applications use data analytics, mobile and artificial intelligence.

Currently, loaning of small amounts can be done solely between the financial institution and an individual. Currently, all the loan systems process for small quantities (e.g. micro-credit) are cumbersome and don't have clearly stated conditions of the transaction. Usually, the interest rates for people seeking credit are not very enticing, and are not negotiable.

Furthermore, the illustrative embodiments recognize and take into account that payroll companies, as a provider of human capital management services, have lots of employee data and payroll information. Payroll companies, as a provider of human capital management services, are uniquely situated to access risks and understand financial behavior of an organization's employees. This valuable information can be used to quickly assess risks of a loaning process.

The methods and systems of the illustrative embodiments use data analytics based on payroll and HCM systems, in order to connect two profiles of workers: (1) workers in emergent need of micro-loans and (2) workers with extra resources willing to loan money at a very enticing rate with very low risk. As the customer base inside payroll and HCM systems is large and potentially spread in several countries; the method could find both people needing micro-loans and also people interested in providing loans at very enticing rates. Also, payroll companies can use the payroll transactions between borrowers and lenders as well to significantly reduce risk in the transaction.

Currently, there is no platform available for people seeking to complete transactions for the welfare of other individuals who have low risk, and in which their profile will be recognized in doing so in future transactions. The methods and systems of the illustrative embodiments simplifies the micro-loaning process and reduces risks, facilitating the process and making everything transparent, with the trust in the transaction being reinforced by the distributed network, and in distributed databases such as blockchain, as well as the payroll reinforcement from the borrowers side. In this case, a lender can be sure that if payment is not fulfilled, it will be directly subtracted from the borrower's payroll in subsequent months. Currently, there is no method or application in which the risk of a loan is enforced in a trust network between individuals.

The flowcharts and block diagrams in the different depicted embodiments illustrate the architecture, functionality, and operation of some possible implementations of apparatuses and methods in an illustrative embodiment as it relates to the disclosed application. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added, in addition to the illustrated blocks, in a flowchart or block diagram.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, and without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, and without limitation, two of item A, one of item B, and ten of item C; four of item B and seven of item C; or other suitable combinations.

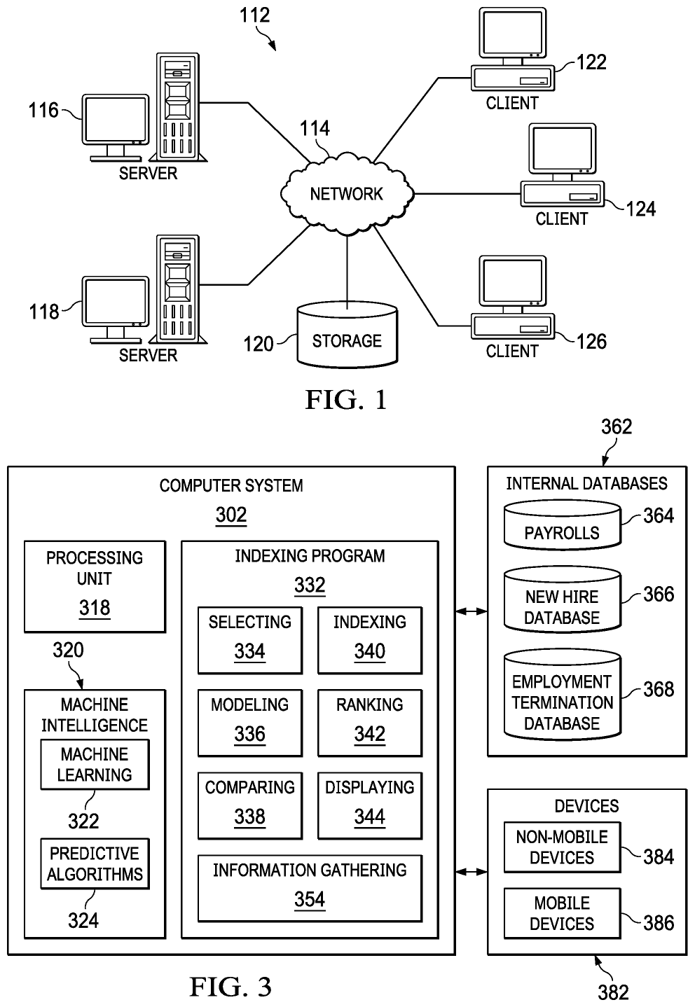

With reference now to the figures and, in particular, with reference to FIG. 1, an illustration of a diagram of a data processing environment is depicted in accordance with an illustrative embodiment. It should be noted that FIG. 1 is only provided as an illustration of one implementation and is not intended to imply any limitation with regard to the environments in which the different embodiments may be implemented. Many modifications to the depicted environments may be made.

FIG. 1 depicts a pictorial representation of a network of data processing systems in which illustrative embodiments may be implemented. Network data processing system 112 is a network of computers in which the illustrative embodiments may be implemented. Network data processing system 112 contains network 114, which is a medium used to provide communications links between various devices and computers connected together within network data processing system 112. Network 114 may include connections, such as wire, wireless communication links, or fiber optic cables.

In the depicted example, server computer 116 and server computer 118 connect to network 114 along with storage unit 120. In addition, client computers including client computer 122, client computer 124, and client computer 126 connect to network 114. These connections can be wireless or wired connections depending on the implementation. Client computer 122, client computer 124, and client computer 126 may be, for example, personal computers or network computers. In the depicted example, server computer 116 provides information, such as boot files, operating system images, and applications to client computer 122, client computer 124, and client computer 126. Client computer 122, client computer 124, and client computer 126 are clients to server computer 116 in this example. Network data processing system 112 may include additional server computers, client computers, and other devices not shown.

Program code located in network data processing system 112 may be stored on a computer-recordable storage medium and downloaded to a data processing system or other device for use. For example, the program code may be stored on a computer-recordable storage medium on server computer 116 and downloaded to client computer 122 over network 114 for use on client computer 122.

In the depicted example, network data processing system 112 is the Internet with network 114 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 112 also may be implemented as a number of different types of networks, such as, for example, an intranet, a local area network (LAN), or a wide area network (WAN).

FIG. 1 is intended as an example, and not as an architectural limitation for the different illustrative embodiments. The illustration of network data processing system 112 is also not meant to limit the manner in which other illustrative embodiments can be implemented. For example, other client computers may be used in addition to or in place of client computer 122, client computer 124, and client computer 126 as depicted in FIG. 1. Moreover, client computer 122, client computer 124, and client computer 126 may include a tablet computer, a laptop computer, a bus with a vehicle computer, and other suitable types of clients.

In the illustrative examples, the hardware used may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

The computer-readable program instructions may also be loaded onto a computer, a programmable data processing apparatus, or other device to cause a series of operational steps to be performed on the computer, a programmable apparatus, or other device to produce a computer implemented process, such that the instructions which execute on the computer, the programmable apparatus, or the other device implement the functions and/or acts specified in the flowchart and/or block diagram block or blocks.

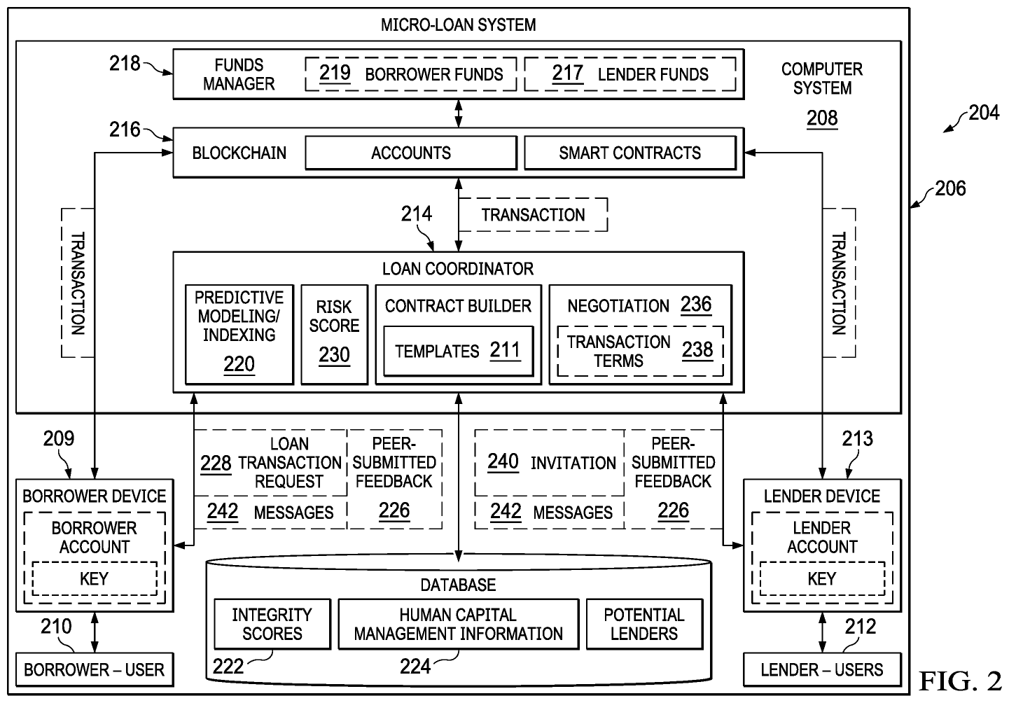

With reference now to FIG. 2, a block diagram of a micro-loan environment is depicted in accordance with an illustrative embodiment. As depicted, micro-loan environment 204 includes micro-loan system 206.

In this illustrative example, micro-loan system 206 manages micro-loan transactions between users associated with one or more organizations. The organizations may be, for example, a corporation, a partnership, a charitable organization, a city, a government agency, or some other suitable type of organization. Organizations can encompass people who are employed by or associated with the organization. Users of micro-loan system 206 can be an employee of one or more organizations of the organizations.

In this illustrative example, micro-loan system 206 is implemented in computer system 208. Computer system 208 is an example of network data processing system 112 of FIG. 1.

Micro-loan system 206 may be implemented in software, hardware, firmware, or a combination thereof. When software is used, the operations performed by micro-loan system 206 may be implemented in program code configured to run on hardware, such as a processor unit. When firmware is used, the operations performed by micro-loan system 206 may be implemented in program code and data and stored in persistent memory to run on a processor unit. When hardware is employed, the hardware may include circuits that operate to perform the operations in micro-loan system 206.

In this illustrative example, micro-loan system 206 facilitates peer-to-peer micro-loan transactions between borrower-user 210 and lender-users 212. The distributed computing, and trust enabled, by micro-loan system 206 allows users greater control over the negotiation of transaction terms-loan, as well as provides transparency and insight into the lending process.

Micro-loan system 206 includes one or more different components. As depicted, micro-loan system 206 includes loan coordinator 214, blockchain 216, and funds manager 218. Using predictive modeling/indexing 220, loan coordinator 214 determines integrity scores 222 for each user of a plurality of users. Integrity scores 222 for each user is based on human capital management information 224 for the user and peer-submitted feedback 226 about the user.

In response to receiving a loan transaction request 228 from borrower-user 210, loan coordinator 214 determines a risk score 230 for the loan transaction. Loan coordinator 214 determines a risk score 230 based at least on integrity scores 222 of borrower-user 210, as well as in the information available in the capital management system.

Loan coordinator 214 identifies a set of lender-users 212 based on the determined ones of risk score 230 and integrity scores 222 of potential ones of lender-users 212. In response to identifying the set of lender-users 212, loan coordinator 214 sends invitation 240 to the set of lender-users 212

Loan coordinator 214 facilitates a negotiation 236 between borrower-user 210 and the set of lender-users 212 to determine transaction terms 238. In one illustrative example, loan coordinator 214 functions as an intermediary, passing messages 242 between borrower device 209 of borrower-user 210 and lender device 213 of the set of lender-users 212. Lender-users 212 can enter initial values for transaction terms 238 using one or more of templates 211. One or more values for values for transaction terms 238 can be altered during the course of negotiation 236.

Responsive to finalization of the transaction terms, loan coordinator 214 records the loan transaction and the transaction terms in blockchain 216. Blockchain 216 is a type of distributed ledger, which includes digitally recorded, unmodifiable data in packages called blocks. A distributed ledger, as used throughout this document, refers to a computer-only technology that enables the distributed recordation of transactions through a distributed ledger maintained by a network of computers. A distributed ledger is a consensus of replicated, shared, and synchronized digital data geographically spread across multiple computers which may be in different sites, countries, and/or institutions maintained by many different parties. A blockchain is an example of a distributed ledger.

Stated more formally, blockchain 216 is a distributed database that maintains a continuously growing list of ordered records called blocks. Each block contains a timestamp and a link to a previous block, with the hash of the prior block linking the two. By design, blockchains are inherently resistant to modification of the data because, once recorded, the data in a block cannot be altered retroactively. Through the use of a peer-to-peer network, and one or more distributed timestamping servers, a blockchain database may be managed autonomously. Thus, blockchains may be used to provide an open, distributed ledger that can record transactions between parties efficiently and in a verifiable and permanent way.

Responding to finalization of the transaction terms, loan coordinator 214 remits lender funds 217 to the borrower-user 210. Loan coordinator 214 can remit lender funds 217 by interacting with funds manager 218 as described below.

In this manner, loan coordinator 214 can use payroll transactions as a way to further reduce risks associated with providing loans. For example, lender-users 212 can be assured of receiving repayment, by discounting borrower funds 219 from the paycheck of borrower-user 210, as agreed to and digitally signed by both parties, and as recorded in blockchain 216. Responding to a subsequent repayment of borrower funds 219 for the loan transaction according to the transaction terms, loan coordinator 214 solicits peer-submitted feedback 226 from at least one of borrower-user 210 and the set of lender-users 212.

Loan coordinator 214 updates the integrity score for borrower-user 210 and the set of lender-users 212 based on received peer-submitted feedback 226 regarding the loan transaction.

Turning to FIG. 3, a block diagram of a predictive modeling/indexing is depicted in accordance with an illustrative embodiment. Computer system 302 is connected to internal databases 362, and devices 382. Internal databases 362 comprise payrolls 364, new hire database 366, and employment termination database 368. Devices 382 are comprised of non-mobile devices 384 and mobile devices 386.

Computer system 302 comprises processing unit 318, machine intelligence 320, and indexing program 332. Machine intelligence 320 comprises machine learning 322 and predictive algorithms 324. Machine learning 322 is a branch of artificial intelligence (AI) that enables computers to detect patterns and improve performance without direct programming commands. Rather than relying on direct input-commands to complete a task, machine learning 322 relies on input-data. The data is fed into the machine, one of predictive algorithms 324 is selected, parameters for the data are configured, and the machine is instructed to find patterns in the input data through optimization algorithms. The data model formed from analyzing the data is then used to predict future values.

Machine intelligence 320 can be implemented using one or more systems such as an artificial intelligence system, a neural network, a Bayesian network, an expert system, a fuzzy logic system, a genetic algorithm, or other suitable types of systems. Machine learning 322 and predictive algorithms 324 may make computer system 302 a special purpose computer for dynamic predictive modelling of the ability of local area economies to hire additional workers.

In an embodiment, processing unit 318 comprises one or more conventional general-purpose central processing units (CPUs). In an alternate embodiment, processing unit 318 comprises one or more graphical processing units (GPUs). Though originally designed to accelerate the creation of images with millions of pixels whose frames need to be continually recalculated to display output in less than a second, GPUs are particularly well suited to machine learning. Their specialized parallel processing architecture allows them to perform many more floating-point operations per second than a CPU, on the order of 1100× more. GPUs can be clustered together to run neural networks comprising hundreds of millions of connection nodes.

Indexing program 332 comprises information gathering 354, selecting 334, modeling 336, comparing 338, indexing 340, ranking 342, and displaying 344. Information gathering 354 is configured to gather data from internal databases 362.

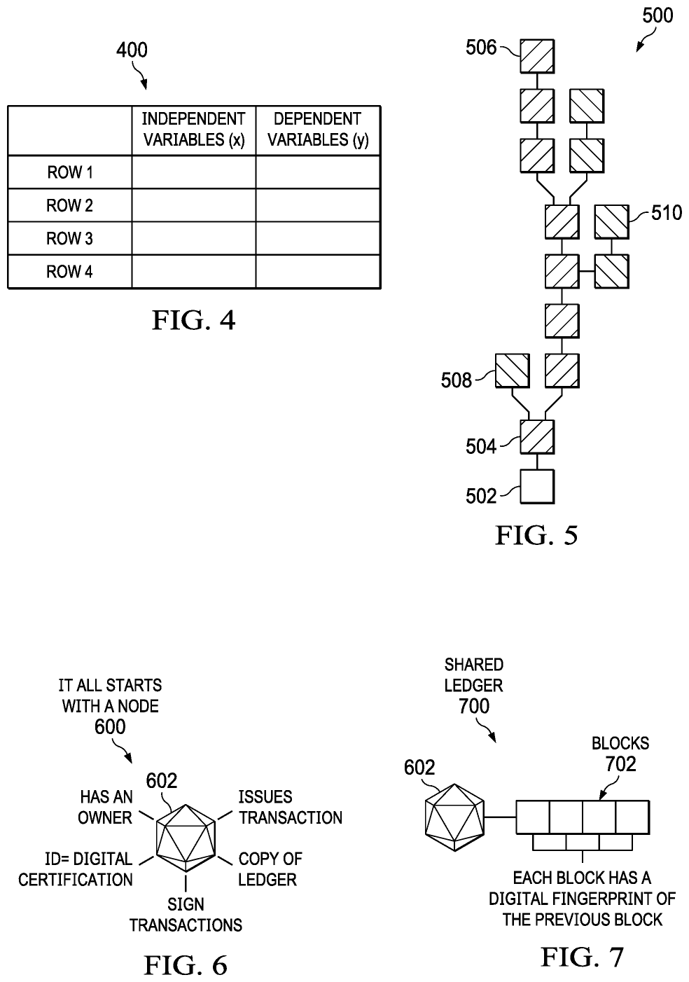

Referring to FIG. 4, an example table for use with a dataset in machine learning is depicted in accordance with an illustrative embodiment. The dataset used to form predictions is defined and labeled in a table such as table 400. Each column is known as a vector, and the data within each column is a feature, also known as a variable, dimension, or attribute. Each row represents a single observation of a given feature and is referred to as a case or value. The y values represent the output and are typically expressed in the final column as shown. For ease of illustration the example shown in FIG. 4 is a simple 2-D table, but it should be noted that multiples vectors (forming matrices) are typically used to represent large datasets. Each category of data calculated in the process flow could be represented by a separate vector (column) in a tabular dataset depending on how the data is aggregated.

FIG. 5 is an illustration of a distributed ledger in the form of a blockchain depicted in accordance with an illustrative embodiment. Blockchain 500 is a blockchain, which is a specific implementation of a distributed ledger. Blockchain 500 is described to introduce blockchain concepts.

Blockchain 500 starts with root block 502. Blocks indicated with a right-leaning hash, such as block 504 or block 506, are part of the main chain. Blocks with a left-leaning hash, such as block 508 or block 510, exist outside of blockchain 500.

Thus, blockchain 500 is a heaviest path from root block 502 to block 506 through the entire block tree. The “heaviest” path through the block tree, i.e. the path that has had the most computation done upon it, is conceptually identified as blockchain 500. Identifying blockchain 500 in this manner allows a decentralized consensus to be achieved for the state of blockchain 500.

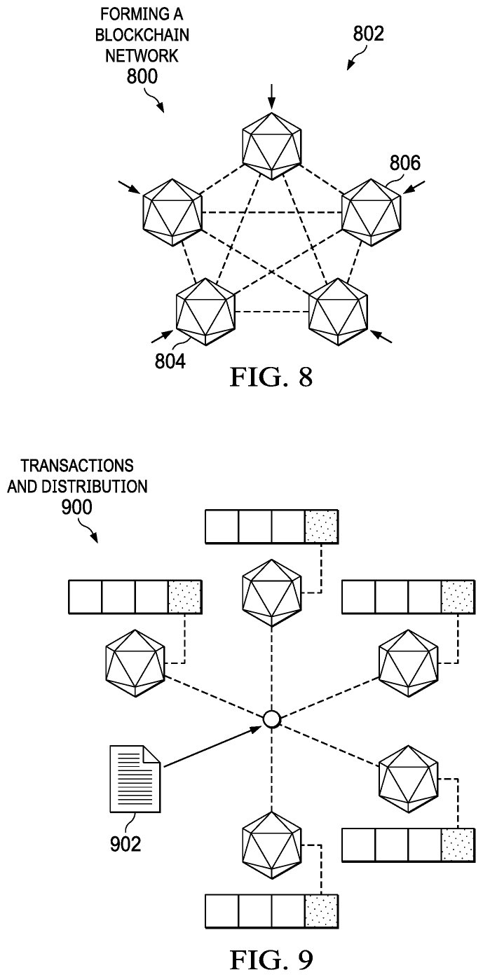

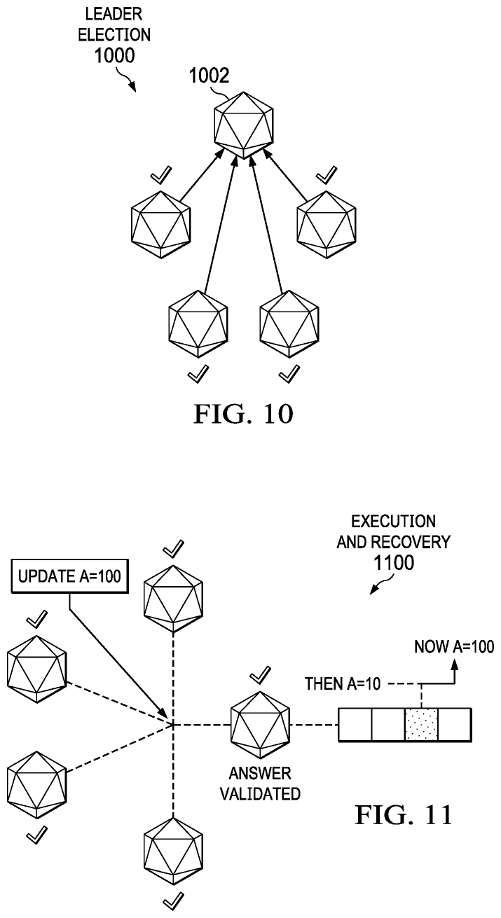

FIG. 6 through FIG. 11 should be considered together. FIG. 6 is an illustration of a first step in creating a blockchain in accordance with an illustrative embodiment. FIG. 7 is an illustration of a second step in creating a blockchain in accordance with an illustrative embodiment. FIG. 8 is an illustration of a third step in creating a blockchain in accordance with an illustrative embodiment. FIG. 9 is an illustration of a fourth step in creating a blockchain in accordance with an illustrative embodiment. FIG. 10 is an illustration of a fifth step in creating a blockchain in accordance with an illustrative embodiment. FIG. 11 is an illustration of a sixth step in creating a blockchain in accordance with an illustrative embodiment. FIG. 6 through FIG. 11 may be implemented on a computer or on multiple computers in a network environment. FIG. 6 through FIG. 11 address a technical problem that only exists in computer programming and execution. As used throughout FIG. 6 through FIG. 11, common reference numerals refer to common objects in these figures.

In operation 600 shown in FIG. 6, account 602, also sometimes referred to as a “node,” is a state object recorded in a shared ledger that represents the identity of agents that can interact with the ledger. Account 602 includes an owner, a digital certificate identification, and a copy of a ledger. Account 602 may sign transactions and inspect the blockchain and its associated state. A user may issue transactions, signed by account 602, to interact with the blockchain. The combined state of all accounts that have interacted with the blockchain is the state of the blockchain.

In operation 700 shown in FIG. 7, account 602 collates transactions and distributions into blocks 702, and adds blocks 702 to the shared ledger. Blocks 702 function as a journal, recording a series of transactions together with the previous block and an identifier for the final state of the blockchain. Blocks 702 are chained together using a cryptographic hash as a means of reference—each block in the shared ledger has a digital fingerprint of the previous block. In this manner, it is not possible to alter previous blocks without being detected.

In operation 800 shown in FIG. 8, blockchain network 802 is formed. Blockchain network 802 may include multiple local copies of blockchains such as those shown in FIG. 6 or FIG. 7. Each account, such as account 804 or account 806, has its own blockchain.

In operation 900 shown in FIG. 9, transaction 902 is issued from an account, such as account 804 or account 806 in FIG. 8. Transaction 902 is an instruction constructed and cryptographically-signed by an account, such as such as account 804 or account 806 in FIG. 8.

Transaction 902 can result in message calls to other accounts. Transactions that result in message calls contain data specifying input data for the message. Alternatively, transaction 902 can result in the creation of new agent accounts, i.e., “contract creation” transactions.

Transactions are collated into blocks that are added to local blockchain copies by the various accounts. The blockchain is synchronized across the various nodes. Thus, each account in blockchain network 802 in FIG. 8 adds identical blocks to a local copy of the blockchain.

In operation 1000 shown in FIG. 10, leader election takes place. Leader account 1002 takes priority for deciding which information is the most accurate or up-to-date. Identifying information by leader account 1002, and validating this information by other accounts, allows a decentralized consensus to be achieved throughout the blockchain network 802 for the state of blockchain 500.

In operation 1100 shown in FIG. 11, data execution and recovery takes place. A query regarding data stored in one or more of the nodes may return a validated answer regarding contents in the blocks.

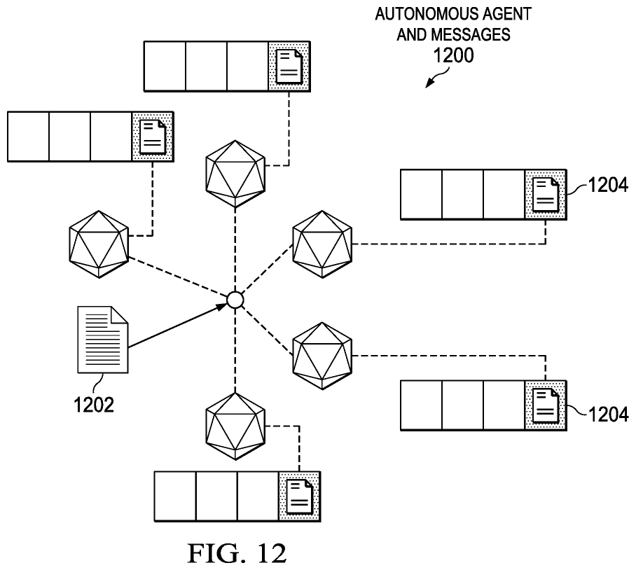

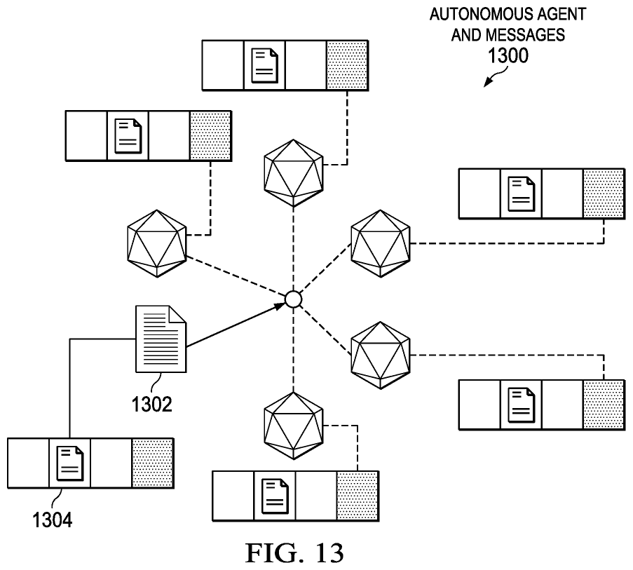

FIG. 12 and FIG. 13 should be considered together. FIG. 12 is an illustration of a step in creating a smart contract within a blockchain in accordance with an illustrative embodiment. FIG. 13 is an illustration of a step in creating a blockchain using a smart contract within a blockchain in accordance with an illustrative embodiment. FIG. 12 and FIG. 13 may be implemented on a computer or on multiple computers in a network environment.

In operation 1200 shown in FIG. 12, transaction 1202 is a “contract creation” transaction that results in the creation of smart contract 1204. In contrast to data contained in message call transactions, such as transaction 1202 in FIG. 12, transaction 1202 contains data specifying initialization code for smart contract 1204.

Smart contract 1204 is a type of account existent only within the blockchain execution environment. Smart contract 1204 is not associated with an external account, but rather is a notional object stored that resides at a specific address on the blockchain. Smart contract 1204 includes both code, i.e. functions, and data, i.e. state. Smart contract 1204 has direct control over its own state and storage memory to preserve persistent state variables. When referenced, either through a transaction or due to the internal execution of code, smart contract 1204 executes its associated functions.

Smart contracts have a number of desirable properties. Execution of the smart contract is managed automatically by the network. Documents are encrypted on a shared ledger that is duplicated many times over on different nodes of the network, ensuring that the data is true and correct. Because smart contracts on distributed ledgers cannot be modified, they provide an immutable record of submitted workflow transactions that is highly resistant to post-transaction changes.

Transaction 1202 contains data specifying initialization code for smart contract 1204. Each account in a blockchain network executes this initialization code to incorporate smart contract 1204 into the blockchain. At creation, smart contract 1204, initialization code is executed to retrieve the associated functions of smart contract 1204, after which the initialization code can be discarded.

In operation 1300 shown in FIG. 13, smart contract 1204 generates message 1302. Message 1302 is an instruction constructed by smart contract 1304 in response to receiving a message. Because smart contract 1304 exists only within the blockchain execution environment, message 1302 is a sort of “virtual transaction” sent by code from one account to another.

Message 1302 can specify input data that results in message calls for other accounts, allowing smart contract 1304 to read and write to internal storage. Alternatively, message 1302 can contain data specifying initialization code, allowing smart contract 1304 to create additional smart contracts.

The associated functions of smart contract 1304 can be executed as part of state transition and block validation. If a transaction is added into a block, the code execution spawned by that transaction will be executed by all accounts that download and validate the block.

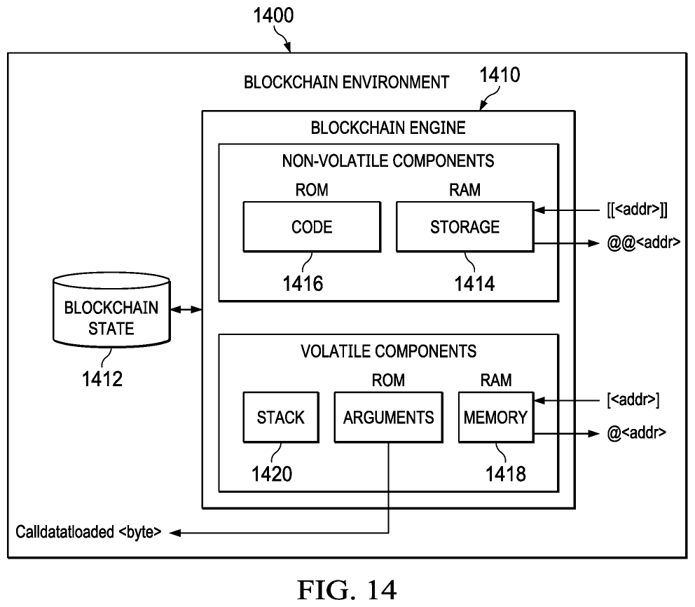

With reference next to FIG. 14, a block diagram of an execution environment for executing a smart contract stored on the blockchain is depicted in accordance with an illustrative embodiment.

Blockchain environment 1400 includes a number of different components. As depicted, blockchain environment 1400 includes blockchain engine 1410 and blockchain state 1412.

Blockchain engine 1410 is responsible for internal-account state and transaction-computation for the blockchain.

Blockchain engine 1410 performs state-transitions for smart contracts. In this illustrative example, blockchain engine 1410 is a stack-based architecture that uses a last-in, first-out stack. Blockchain engine 1410 executes transactions recursively, computing the system state and the machine state for each loop. Blockchain engine 1410 includes non-volatile and volatile components.

Storage 1414 is non-volatile and is maintained on the blockchain as part of the system state. Every smart contract on the blockchain has its own storage. Storage 1414 preserves all the state variables for the smart contract that do not change between the function calls.

Code 1416 are the functions associated with smart contract 1204 and 1304 from FIG. 12 and FIG. 13, respectively. Code 1416 are instructions that formally specify the meaning and ramifications of a transaction or message; code 1416 executes in response to receiving a message call. Code 1416 is stored in a virtual ROM that cannot be changed after construction. Blockchain engine 1410 executes code 1416 in response to a message call to the smart contract.

Memory 1418 is volatile and is cleared between external function calls. Memory 1418 stores temporary data, such as, function arguments, local variables, and return values. Stack 1420 is used to hold temporary values when conducting calculations in blockchain engine 1410.

Blockchain state 1412 is combined state of all accounts that have interacted with the blockchain, mapping blockchain addresses to accounts and account states. Blockchain state 1412 may not be stored on the blockchain, but rather in a data structure on a backend state database that maintains the mapping. Blockchain engine 1410 relies on blockchain state 1412 for execution of certain instructions.

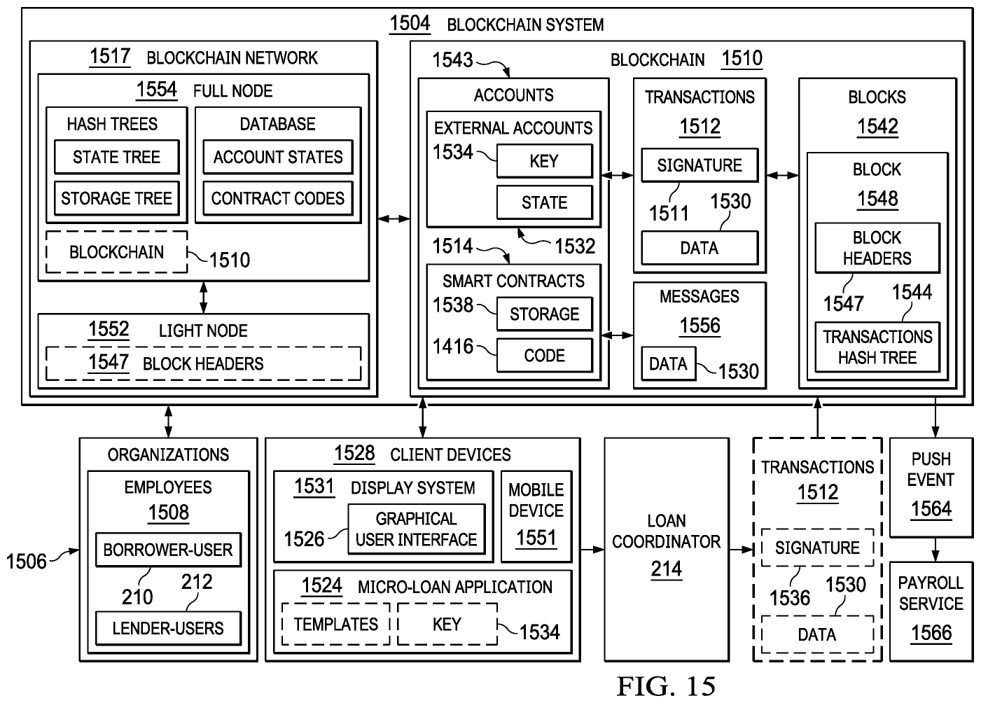

With reference now to FIG. 15, a block diagram of a blockchain in a micro-loan environment is depicted in accordance with an illustrative embodiment. As depicted, blockchain 1510 of blockchain system 1504 can be blockchain 216 of FIG. 2.

In this illustrative example, blockchain system 1504 manages micro-loan transactions for employees 1508 of organizations 1506. The distributed computing and trust enabled by blockchain system 1504 simplifies the micro-loaning process by reducing risks, and providing transparency in the micro-loaning process with the trust in the transaction being reinforced by the distributed network.

Responding to finalization of transaction terms 238 of FIG. 2, loan coordinator 214 records the loan transaction and the transaction terms in blockchain 1510. Once transaction terms 238 are finalized, loan coordinator 214 submits transactions 1512 that includes signature 1511 of loan coordinator 214 and data 1530 for creating one of smart contracts 1514 based on the finalized ones of transaction terms 238 from FIG. 2. In one illustrative example, smart contracts 1514 may require a separate transaction, signed by each contracting user, for example, borrower-user 210 and lender-users 212 of FIG. 2, accepting the finalized terms of the smart contract prior before any funds are transferred.

Users interact with micro-loan application 1524 through user input to graphical user interface 1526 using one or more user input devices, such as a keyboard, a mouse, a graphical user interface (a physical display), a touch screen, a voice interaction, and any other suitable interface for interacting with the computer. In one illustrative example, micro-loan application 1524 can be a mobile phone application (mobile app) that is available in a variety of mobile platforms, such as but not limited to, Apple iOS, Android, Windows Phone OS, Blackberry OS, webOS, and Symbian OS.

In one illustrative example, client devices 1528, which can include one or more of borrower device 209 and lender device 213 of FIG. 2, display graphical user interface 1526 on display system 1531. In this illustrative example, display system 1531 can be a group of display devices. A display device in display system 1531 may be selected from one of a liquid crystal display (LCD), a light emitting diode (LED) display, an organic light emitting diode (OLED) display, and other suitable types of display devices.

External accounts 1532 are examples of account 804 and account 806 shown in block form in FIG. 8. External accounts 1532 allow external actors, such as borrower-user 210, lender-users 212, and loan coordinator 214 and to interact with blockchain 216 by issuing transactions 1512, signed using key 1534.

Transactions 1512 submitted from loan coordinator 214 and are cryptographically-signed to uniquely identify a particular account. For example, blockchain system 1504 is able to uniquely identify which of borrower-user 210, lender-users 212, and loan coordinator 214 issues the transaction based on the unique signature 1536 created using key 1534. Based on the unique signature 1536 created, each node in blockchain network 1517 can use the corresponding one of key 1534 to identify the corresponding one of external accounts 1532 that issued the transaction.

In this illustrative example, transaction 1512 is a “contract creation” transaction that includes data 1530 specifying initialization code for one of smart contracts 1514. Additionally, data 1530 can specify input data for one or more of smart contracts 1514, such as transaction terms 238 entered into one or more templates 211 of FIG. 2. Once created, smart contracts 1514 store transaction terms 238 in its associated storage 1538 as part of the smart contract's associated state.

In this manner, blockchain system 1504 records the loan transaction and the transaction terms in blockchain 1510 by generating one of smart contracts 1514 for the loan transaction based on transaction terms 238 of FIG. 2, and recording the smart contract in blockchain 1510. Blockchain system 1504 manages a loan balance within smart contracts 1514 according to transaction terms 238 and based on repayment transactions submitted from borrower-user 210, lender-users 212, and recorded on the blockchain.

Blockchain system 1504 records transactions 1512 in blocks 1542 of blockchain 1510. Each of transactions 1512 is hashed and stored in transactions hash tree 1544 of an associated one of blocks 1542. All of the transaction hashes in transactions hash tree 1544 are themselves hashed and stored as a root hash as part of block headers 1547.

Block headers 1547 are smaller than the entire associated block 1548. Using a distributed hash table as a database, mobile device 1551 can operate as light client node 1552 that stores just block headers 1547 of blockchain 1510. Light client node 1552 can obtain blockchain information by communicating with trusted full node 1554. Light client node 1552 allow users in storage-limited or bandwidth-limited environments, such as in applications on mobile device 1551, to maintain a high-security assurance about a current state of some portion of the state of blockchain 1510, or verify the execution of transactions 1512.

In this illustrative example, smart contracts 1514 can generate one or more of messages 1556 in response to the execution of code 1416. Messages 1556 can be sent to other ones of accounts 1543, including external accounts 1532 and other smart contracts 1514. Additionally, messages 1556 generated by smart contracts 1514 can request external accounts 1532 to generate external events, such as push event 1564. Push event 1564 can be, for example, a web hook, a web socket, or some other appropriate communication that communicates timeclock information to an external service, such as payroll service 1566.

For example, blockchain system 1504 associates a URL address for payroll service 1566 with the account of organization 1506 in blockchain system 1504. Blockchain system 1504 pushes a POST request to payroll service 1566. The POST request can comprise a JSON object that includes payroll information to run payroll services for organization 1506. Payroll information in the JSON object can be encrypted.

In this illustrative example, payroll service 1566 is associated with an account, such as one of external accounts 1532, of a payroll service provider. Blockchain system 1504 communicates payroll information to payroll service 1566 through push event 1564. In this illustrative example, push event 1564 communicates payroll information to payroll service 1566, enabling payroll service 1566 to use payroll information to provide payroll services for one or more of organizations 1506 and employees 1508.

In this illustrative example, the set of lender-users are employees of the set of organizations. In running payroll for a set of organizations, payroll service 1566 identifies one of smart contracts 1514 in blockchain 1510 for a loan between borrower-user 210 and lender-users 212. Payroll service 1566 remits lender funds 217 to the borrower-user by subtracting requested funds from scheduled payroll payments to the set of lender-users and adding the requested loan funds to scheduled payroll payments to the borrower-user. Based on the amount of remitted funds, payroll service 1566 can submit additional transactions to blockchain 1510, thereby managing a loan balance that is recorded in storage 1538 of the associated ones of smart contracts 1514.

Additionally, within remitting loan funds to the borrower-user, payroll service 1566 identifies one of smart contracts 1514 in blockchain 1510 for a loan between borrower-user 210 and lender-users 212. Payroll service 1566 remits borrower funds 219 to lender-users 212 according to the terms recorded in smart contracts 1514, by subtracting borrower funds 219 from scheduled payroll payments to the set of borrower-user and adding the funds to scheduled payroll payments to the lender-user. Based on the amount of repaid funds, payroll service 1566 can submit additional transactions to blockchain 1510, thereby managing a loan balance that is recorded in storage 1538 of the associated ones of smart contracts 1514.

In an alternative embodiment, funds manager 218 ,from FIG. 2, has access to an account of both borrower-user 210 and lender-users 212. The accounts can be internal to blockchain 1510, or external to blockchain 1510, such as a bank account, a credit account, or some other source of funds. Funds manager 218 remits loan funds to the borrower-user by subtracting requested loan funds from the account of lender-users and adding the requested loan funds to the account of borrower-user. Based on the amount of remitted funds, funds manager 218 can submit additional transactions to the blockchain, thereby managing a loan balance that is recorded in storage 1538 of the associated ones of smart contracts 1514.

Additionally, within remitting loan funds to the borrower-user, funds manager 218 identifies one of smart contracts 1514 in the blockchain for a loan between borrower-user 210 and lender-users 212. Funds manager 218 remits repayment to lender-users 212 according to the terms recorded in smart contracts 1514, by subtracting repayment loan funds from the account of the set of borrower-user and adding the repayment loan funds to the account of the lender-user. Based on the amount of repaid funds, funds manager 218 can submit additional transactions to the blockchain, thereby managing a loan balance that is recorded in storage 1538 of the associated ones of smart contracts 1514.

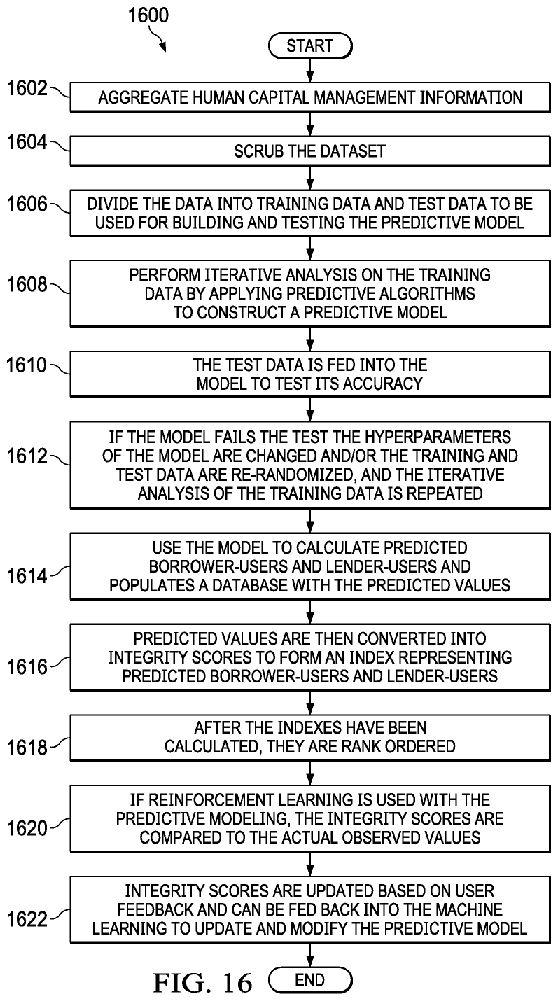

Turning to FIG. 16, an illustration of a flowchart of a process for predictive modeling and indexing is depicted in accordance with an illustrative embodiment. Process 1600 can be implemented in software, hardware, or a combination of the two. When software is used, the software comprises program code that can be loaded from a storage device and run by a processor unit in a computer system such as computer system 208 in FIG. 2. Computer system 208 may reside in a network data processing system such as network data processing system 112 in FIG. 1. For example, computer system 208 may reside on one or more of server computer 116, server computer 118, client computer 122, client computer 124, and client computer 126 connected by network 114 in FIG. 1. Moreover, the process can be implemented by computer system 302 in FIG. 3 and a processing unit such as processing unit 318 in FIG. 3.

Process 1600 begins with aggregate human capital management information, such as human capital management information 224 of FIG. 2 (step 1602). After the dataset is aggregated, process 1600 will scrub the dataset (step 1604). Very large datasets, sometimes referred to as Big Data, often contain noise and complicated data structures. Bordering on the order of petabytes, such datasets comprise a variety, volume, and velocity (rate of change) that defies conventional processing, and is impossible for a human to process without advanced machine assistance. Scrubbing refers to the process of refining the dataset before using it to build a predictive model and includes modifying and/or removing incomplete data or data with little predictive value. It can also entail converting text based data into numerical values (one-hot encoding) or convert numerical values into a category.

After the dataset has been scrubbed, process 1600 will divide the data into training data and test data to be used for building and testing the predictive model (step 1606). To produce optimal results, the same data that is used to test the model should not be the same data used for training. The data is divided by rows, usually with 70-80% used for training and 20-30% used for testing.

Process 1600 will then perform iterative analysis on the training data by applying predictive algorithms to construct a predictive model (step 1608). The algorithm, through trial and error, deciphers the patterns that exist between the input training data and the known output values to create a model that can reproduce the same underlying rules with new data.

There are three main categories of machine learning: supervised, unsupervised, and reinforcement learning. Supervised machine learning comprises providing the machine with test data and the correct output value of the data. Examples of supervised learning algorithms include regression analysis, decisions trees, k-nearest neighbors, neural networks, and support vector machines. Referring back to table 400 in FIG. 4, during supervised learning the values for the y column (output) are provided along with the training data (labeled dataset) for the model building process in step 1608.

After the model is constructed, the test data is fed into the model to test its accuracy (step 1610). In an embodiment the model is tested using mean absolute error, which examines each prediction in the model and provides an average error score for each prediction. If the error rate between the training and test dataset is below a predetermined threshold, the model has learned the dataset's pattern and passed the test.

If the model fails the test: the hyperparameters of the model are changed and/or the training and test data are re-randomized or more data is collected (either through obtaining more samples or through data augmentation), and the iterative analysis of the training data is repeated (step 1612). Hyperparameters are the settings of the algorithm that control how fast the model learns patterns and which patterns to identify and analyze. Once a model has passed the test stage it is ready for application.

Whereas supervised and unsupervised learning reach an endpoint after a predictive model is constructed and passes the test in step 1610, reinforcement learning continuously improves its model using feedback from application to new empirical data. Algorithms such as Q-learning are used to train the predictive model through continuous learning using measurable performance criteria (discussed in more detail below).

After the model is constructed and tested for accuracy, process 1600 will use the model to calculate predicted borrower-users and lender-users and populates a database with the predicted values (step 1614).

The predicted values are then converted into integrity scores to form an index representing predicted borrower-users and lender-users (step 1616).

After the indexes have been calculated, they are rank ordered (step 1618). Rank ordering facilitates comparison across different users and integrity scores.

If reinforcement learning is used with the predictive modelling, the integrity scores are compared to the actual observed values (step 1620).

Integrity scores are updated based on user feedback and can be fed back into the machine learning to update and modify the predictive model (step 1622). The process terminates thereafter.

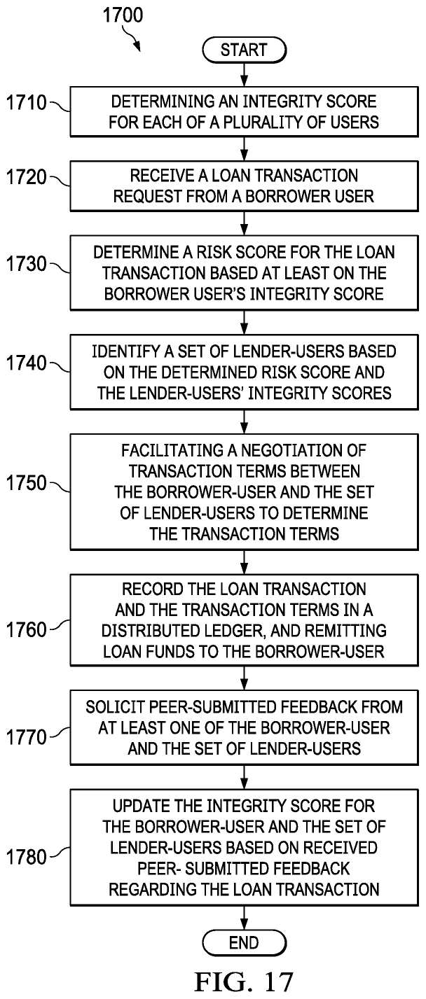

With reference next to FIG. 17, a flowchart of a process for facilitating peer-to-peer micro-loan transactions is depicted in accordance with an illustrative embodiment. The process of FIG. 13 can be a software process implemented in one or more components of micro-loan system 206 of FIG. 2.

The process begins by determining an integrity score for each user of a plurality of users (step 1710). The integrity score for each user is based on human capital management information for the user and peer-submitted feedback about the user.

The process will then receive a loan transaction request from a borrower-user (step 1720). Afterwards, the process will determine a risk score for the loan transaction based at least on the borrower-user's integrity score (step 1730). The process will then identify a set of lender-users based on the determined risk score and the lender-users' integrity scores (step 1740).

Afterwards, the process will then allow for facilitating a negotiation of transaction terms between the borrower-user and the set of lender-users to determine the transaction terms (step 1750).

Responding to finalization of the transaction terms, the process will then record the loan transaction and the transaction terms in a distributed ledger, and remitting loan funds to the borrower-user (step 1760).

Responsive to a subsequent repayment of the loan transaction according to the transaction terms, the process then will solicit peer-submitted feedback from at least one of the borrower-user and the set of lender-users (step 1770).

The process will then update the integrity score for the borrower-user and the set of lender-users based on received peer-submitted feedback regarding the loan transaction (step 1780), with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

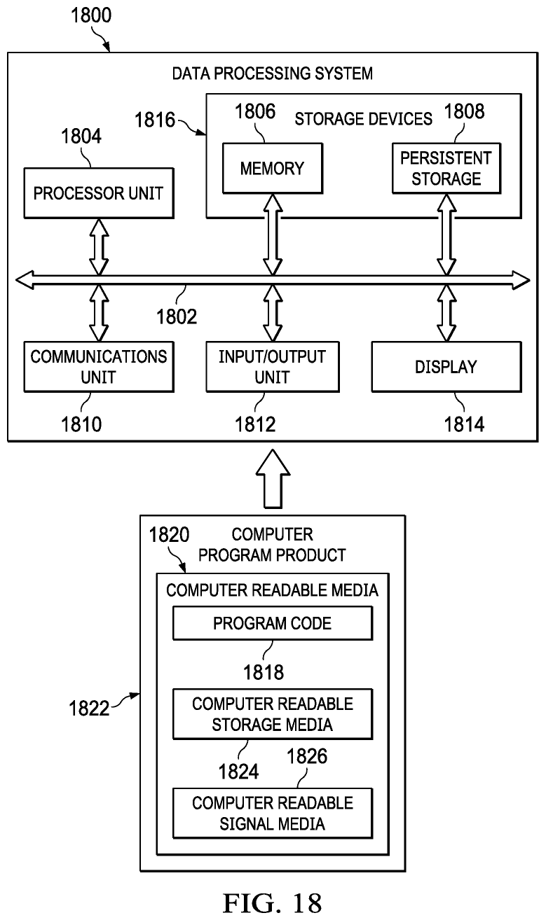

Turning now to FIG. 18, an illustration of a block diagram of a data processing system is depicted in accordance with an illustrative embodiment. Data processing system 1800 may be used to implement computer system 208 and other data processing systems that may be used in micro-loan environment 204 in FIG. 2.

In this illustrative example, data processing system 1800 includes communications framework 1802, which provides communications between processor unit 1804, memory 1806, persistent storage 1808, communications unit 1810, input/output (I/O) unit 1828, and display 1814. In this example, communications framework 1802 may take the form of a bus system.

Processor unit 1804 serves to execute instructions for software that may be loaded into memory 1806. Processor unit 1804 may be a number of processors, a multi-processor core, or some other type of processor, depending on the particular implementation.

Memory 1806 and persistent storage 1808 are examples of storage devices 1816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1816 may also be referred to as computer readable storage devices in these illustrative examples. Memory 1806, in these examples, may be, for example, a random access memory or any other suitable volatile or non-volatile storage device. Persistent storage 1808 may take various forms, depending on the particular implementation.

For example, persistent storage 1808 may contain one or more components or devices. For example, persistent storage 1808 may be a hard drive, a solid state hard drive, a flash memory, a rewritable optical disk, a rewritable magnetic tape, or some combination of the above. The media used by persistent storage 1808 also may be removable. For example, a removable hard drive may be used for persistent storage 1808.

Communications unit 1810, in these illustrative examples, provides for communications with other data processing systems or devices. In these illustrative examples, communications unit 1810 is a network interface card.

Input/output unit 1812 allows for input and output of data with other devices that may be connected to data processing system 1800. For example, input/output unit 1812 may provide a connection for user input through at least one of a keyboard, a mouse, or some other suitable input device. Further, input/output unit 1812 may send output to a printer. Display 1814 provides a mechanism to display information to a user.

Instructions for at least one of the operating system, applications, or programs may be located in storage devices 1816, which are in communication with processor unit 1804 through communications framework 1802. The processes of the different embodiments may be performed by processor unit 1804 using computer-implemented instructions, which may be located in a memory, such as memory 1806.

These instructions are referred to as program code, computer usable program code, or computer readable program code that may be read and executed by a processor in processor unit 1804. The program code in the different embodiments may be embodied on different physical or computer readable storage media, such as memory 1806 or persistent storage 1808.

Program code 1818 is located in a functional form on computer readable media 1820 that is selectively removable and may be loaded onto or transferred to data processing system 1800 for execution by processor unit 1804. Program code 1818 and computer readable media 1820 form computer program product 1822 in these illustrative examples. In one example, computer readable media 1820 may be computer readable storage media 1824 or computer readable signal media 1826.

In these illustrative examples, computer readable storage media 1824 is a physical or tangible storage device used to store program code 1818 rather than a medium that propagates or transmits program code 1818.

Alternatively, program code 1818 may be transferred to data processing system 1800 using computer readable signal media 1826. Computer readable signal media 1826 may be, for example, a propagated data signal containing program code 1818. For example, computer readable signal media 1826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1800 are not meant to provide architectural limitations to the manner in which different embodiments may be implemented. The different illustrative embodiments may be implemented in a data processing system including components in addition to or in place of those illustrated for data processing system 1800. Other components shown in FIG. 18 can be varied from the illustrative examples shown. The different embodiments may be implemented using any hardware device or system capable of running program code 1818.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1.-21. (canceled)

22. A method for facilitating blockchain-based micro transactions via machine learning, comprising:
aggregating, by a micro-loan system comprising a hardware processor, data regarding a plurality of factors associated with human capital management information and a plurality of users;
scrubbing, by the micro-loan system, the aggregated data to generate a refined dataset;
splitting, by the micro-loan system, the refined dataset into a training dataset and a testing dataset;
constructing, by the micro-loan system via execution of machine learning on the training dataset, a model configured to predict categories for the plurality of users, the categories indicating at least one of borrower or lender;
determining, by the micro-loan system, a plurality of integrity scores for the plurality of users based on the categories predicted by the model and feedback about the plurality of users;
receiving, by the micro-loan system, a request for a loan transaction from a first user of the plurality of users;
determining, by the micro-loan system, a risk score for the loan transaction based at least on a first integrity score of the plurality of integrity scores for the first user indicating the first user is predicted by the model to be the borrower;
identifying, by the micro-loan system, a plurality of lenders from the plurality of users based on the determined risk score and integrity scores of the plurality of integrity scores corresponding to the plurality of lenders;
facilitating, by the micro-loan system, a negotiation of transaction terms between the borrower and the plurality of lenders to determine the transaction terms;
recording, by the micro-loan system responsive to finalization of the transaction terms, the loan transaction and the transaction terms in a smart contract on a blockchain maintained by a network of computers;
soliciting, by the micro-loan system responsive to a subsequent repayment of loan transaction according to the transaction terms recorded on the blockchain, additional feedback from at least one of the borrower and the plurality of lenders; and
updating, by the micro-loan system via machine learning, the model based on the feedback to configure the model to modify at least one integrity score of the plurality of integrity scores.

23. The method of claim 22, comprising:
performing, by the micro-loan system, iterative analysis on the training dataset using the machine learning to construct the model, wherein the machine learning comprises at least one of a regression, a decision tree, k-nearest neighbors, neural networks, or a support vector machine;
generating, by the micro-loan system, the plurality of integrity scores for the plurality of users over a specified time period to create indices of integrity scores; and
rank ordering, by the micro-loan system, the plurality of users based on the corresponding indices of integrity scores.

24. The method of claim 22, comprising:
determining, by the micro-loan system, an error rate of an initial model generated via machine learning using the training dataset;
comparing, by the micro-loan system, the error rate of the initial model with a threshold;
changing, by the micro-loan system responsive to the error rate greater than or equal to the threshold, a hyperparameter used to generate the initial model;
retraining, by the micro-loan system, the initial model with the changed hyperparameter to construct the model;
determining, by the micro-loan system, a second error rate of the model is less than the threshold; and
deploying, by the micro-loan system, the model re-trained with the changed hyperparameter to predict the categories for the plurality of users.

25. The method of claim 22, comprising:
remitting, via the micro-loan system, loan funds to the borrower in accordance with the transaction terms.

26. The method of claim 22, comprising:
running, by the micro-loan system, payroll for a set of organizations, wherein the plurality of lenders are employees of the set of organizations; and
subtracting, by the micro-loan system, requested loan funds from scheduled payroll payments to the plurality of lenders to execute a remittance of the requested loan funds.

27. The method of claim 22, comprising:
adding, by the micro-loan system, requested loan funds to scheduled payroll payments to the borrower; and
depositing, by the micro-loan system, the requested loan funds into a registered account of the borrower to execute a remittance of the requested loan funds.

28. The method of claim 22, comprising:
running, by the micro-loan system, payroll for a set of organizations, wherein the borrower is an employee of the set of organizations; and
subtracting, by the micro-loan system, repayment funds from scheduled payroll payments to the borrower to execute a remittance of repayment funds to the plurality of lenders in accordance with the transaction terms.

29. The method of claim 22, comprising:
adding, by the micro-loan system, repayment funds to scheduled payroll payments to the plurality of lenders; and
depositing, by the micro-loan system, the repayment funds into a set of registered accounts of the plurality of lenders to execute a remittance of repayment funds to the plurality of lenders in accordance with the transaction terms.

30. The method of claim 22, comprising:
adding, by the micro-loan system, repayment funds to scheduled payroll payments to the plurality of lenders; and
depositing, by the micro-loan system, the repayment funds into a set of registered accounts of the plurality of lenders to execute a remittance of repayment funds to the plurality of lenders in accordance with the transaction terms.

31. A system to facilitate blockchain-based micro transactions via machine learning, comprising:
a micro-loan system comprising a hardware processor, the micro-loan system configured to:
aggregate data regarding a plurality of factors associated with human capital management information and a plurality of users;
scrub the aggregated data to generate a refined dataset;
split the refined dataset into a training dataset and a testing dataset;
construct, via execution of machine learning on the training dataset, a model configured to predict categories for the plurality of users, the categories to indicate at least one of borrower or lender;
determine a plurality of integrity scores for the plurality of users based on the categories predicted by the model and feedback about the plurality of users;
receive a request for a loan transaction from a first user of the plurality of users;
determine a risk score for the loan transaction based at least on a first integrity score of the plurality of integrity scores for the first user that indicates the first user is predicted by the model to be the borrower;
identify a plurality of lenders from the plurality of users based on the determined risk score and integrity scores of the plurality of integrity scores corresponding to the plurality of lenders;
facilitate a negotiation of transaction terms between the borrower and the plurality of lenders to determine the transaction terms;
record, responsive to finalization of the transaction terms, the loan transaction and the transaction terms in a smart contract on a blockchain maintained by a network of computers;
solicit, responsive to a subsequent repayment of loan transaction according to the transaction terms recorded on the blockchain, additional feedback from at least one of the borrower and the plurality of lenders; and
update, via machine learning, the model based on the feedback to configure the model to modify at least one integrity score of the plurality of integrity scores.

32. The system of claim 31, comprising the micro-loan system to:
perform iterative analysis on the training dataset using the machine learning to construct the model, wherein the machine learning comprises at least one of a regression, a decision tree, k-nearest neighbors, neural networks, or a support vector machine;
generate the plurality of integrity scores for the plurality of users over a specified time period to create indices of integrity scores; and
rank order the plurality of users based on the corresponding indices of integrity scores.

33. The system of claim 31, comprising the micro-loan system to:
determine an error rate of an initial model generated via machine learning using the training dataset;
compare the error rate of the initial model with a threshold;
change, responsive to the error rate greater than or equal to the threshold, a hyperparameter used to generate the initial model;
retrain the initial model with the changed hyperparameter to construct the model;
determine a second error rate of the model is less than the threshold; and
deploy the model re-trained with the changed hyperparameter to predict the categories for the plurality of users.

34. The system of claim 31, comprising the micro-loan system to:
remit loan funds to the borrower in accordance with the transaction terms.

35. The system of claim 31, comprising the micro-loan system to:
run payroll for a set of organizations, wherein the plurality of lenders are employees of the set of organizations; and
subtract requested loan funds from scheduled payroll payments to the plurality of lenders to execute a remittance of the requested loan funds.

36. The system of claim 31, comprising the micro-loan system to:
add requested loan funds to scheduled payroll payments to the borrower; and
deposit by the micro-loan system, the requested loan funds into a registered account of the borrower to execute a remittance of the requested loan funds.

37. The system of claim 31, comprising the micro-loan system to:
run payroll for a set of organizations, wherein the borrower is an employee of the set of organizations; and
subtract repayment funds from scheduled payroll payments to the borrower to execute a remittance of repayment funds to the plurality of lenders in accordance with the transaction terms.

38. The system of claim 31, comprising the micro-loan system to:
add repayment funds to scheduled payroll payments to the plurality of lenders; and
deposit the repayment funds into a set of registered accounts of the plurality of lenders to execute a remittance of repayment funds to the plurality of lenders in accordance with the transaction terms.

39. A non-transitory computer-readable medium, executing instructions embodied thereon, the instructions to:
aggregate data regarding a plurality of factors associated with human capital management information and a plurality of users;
scrub the aggregated data to generate a refined dataset;
split the refined dataset into a training dataset and a testing dataset;
construct, via execution of machine learning on the training dataset, a model configured to predict categories for the plurality of users, the categories to indicate at least one of borrower or lender;
determine a plurality of integrity scores for the plurality of users based on the categories predicted by the model and feedback about the plurality of users;
receive a request for a loan transaction from a first user of the plurality of users;
determine a risk score for the loan transaction based at least on a first integrity score of the plurality of integrity scores for the first user that indicates the first user is predicted by the model to be the borrower;
identify a plurality of lenders from the plurality of users based on the determined risk score and integrity scores of the plurality of integrity scores corresponding to the plurality of lenders;
facilitate a negotiation of transaction terms between the borrower and the plurality of lenders to determine the transaction terms;
record, responsive to finalization of the transaction terms, the loan transaction and the transaction terms in a smart contract on a blockchain maintained by a network of computers;
solicit, responsive to a subsequent repayment of loan transaction according to the transaction terms recorded on the blockchain, additional feedback from at least one of the borrower and the plurality of lenders; and
update, via machine learning, the model based on the feedback to configure the model to modify at least one integrity score of the plurality of integrity scores.

40. The non-transitory computer-readable medium of claim 39, comprising the instructions to:
perform iterative analysis on the training dataset using the machine learning to construct the model, wherein the machine learning comprises at least one of a regression, a decision tree, k-nearest neighbors, neural networks, or a support vector machine;
generate the plurality of integrity scores for the plurality of users over a specified time period to create indices of integrity scores; and
rank order the plurality of users based on the corresponding indices of integrity scores.

41. The non-transitory computer-readable medium of claim 39, comprising the instructions to:
determine an error rate of an initial model generated via machine learning using the training dataset;
compare the error rate of the initial model with a threshold;
change, responsive to the error rate greater than or equal to the threshold, a hyperparameter used to generate the initial model;
retrain the initial model with the changed hyperparameter to construct the model;
determine a second error rate of the model is less than the threshold; and
deploy the model re-trained with the changed hyperparameter to predict the categories for the plurality of users.
